(19) United States
(12) Patent Application Publication
(10) Pub. No.: US 2007/0270193 A1
(43) Pub. Date: Nov. 22, 2007

(54) Mobile communication device with a sliding mechanism

(76) Inventor: Chang-Ling Hsieh, Taichung City (TW)

Correspondence Address: CHANG-LING HSIEH, 235 CHUNG-HO, BOX 8-24, TAIPEI, omitted

(21) Appl. No.: 11/434,589

(22) Filed: May 16, 2006

(51) Int. Cl. H04M 1/00

(52) U.S. Cl. 455/575.1

(57) ABSTRACT

A mobile communication device with a sliding mechanism comprises a body installed with an IC circuit and a detachable battery; a surface of the body is installed with a display screen and a key set; a cover having an approximate U shape cross section; the cover being slideably combined to the body; at least of side of the cover and body being installed with a liner bearing so that the cover is smoothly slideably with respective to the body. Each of two sides of the body is formed with a track groove and a limiting trench. A metal track sheet is embedded in the track groove; and the limiting trench is received with a guide portion. The linear bearing includes a metal slide guide sheet between two lateral sides of the cover and body and a plurality of rolling balls rotatably embedded into the guide sheet.

### FIELD OF THE INVENTION

The present invention relates to mobile communication devices, and particular to a mobile communication device with a sliding mechanism, wherein the cover can be opened smoothly and easily.

### BACKGROUND OF THE INVENTION

The mobile communication handset with a sliding cover is more and more popular and is possibly to replace the conventional fold type or flip type handset.

In the handset with a sliding cover, a backside of a cover is installed with two track grooves. Each track groove is formed with a guide block. Thereby the cover is slideable with respective to the body.

In above mentioned structure, it is desired that the force applied to the cover must be greater than the friction force between the body and the cover. However the mechanical errors in the body and the body will induce the operation is not so smooth even the user will feel uneasy in opening the cover.

Furthermore, in PDA (personal digital assistance), the sliding cover design is also applied for protecting the display screen. However the above mentioned defect still exists.

### SUMMARY OF THE INVENTION

Accordingly, the primary object of the present invention is to provide a mobile communication device with a sliding mechanism, wherein the cover can be opened smoothly and easily.

To achieve above objects, the present invention provides a mobile communication device with a sliding mechanism. The device comprises a body installed with an IC circuit and a detachable battery; a surface of the body is installed with a display screen and a key set; a cover having an approximate U shape cross section; the cover being slideably combined to the body; at least of side of the cover and body being installed with a liner bearing so that the cover is smoothly slideable with respective to the body. The mobile communication device is a mobile phone; each of two sides of the body is formed with a track groove and a limiting trench; a metal track sheet is embedded in the track groove; and the limiting trench is received with a guide portion. The linear bearing includes a metal slide guide sheet between two lateral sides of the cover and body and a plurality of rolling balls rotatably embedded into the guide sheet.

The various objects and advantages of the present invention will be more readily understood from the following detailed description when read in conjunction with the appended drawing.

### BRIEF DESCRIPTION OF THE DRAWINGS

FIG. 1-1 is a perspective view of the handset with a sliding cover of the present invention.

FIG. 1-2 is a partial enlarged view of the metal track sheet of the handset with a sliding cover of the present invention.

FIG. 2 is a lateral schematic view of the handset with a sliding cover of the present invention.

FIG. 3-1 is a partial perspective view showing a covering state of the handset with a sliding cover of the present invention.

FIG. 3-2 is a perspective view showing a covering state of the handset with a sliding cover of the present invention, wherein the rolling balls of linear bearing fall into the notches.

FIG. 3-3 is a perspective view showing a covering state of the handset with a sliding cover of the present invention, wherein the rolling balls of linear bearing leave from the notch.

FIG. 4 is a schematic view showing an opening state of the handset with a sliding cover of the present invention.

FIG. 5 is perspective view showing the second embodiment of the handset with a sliding cover of the present invention.

FIG. 6 is a schematic view showing an opening state of the handset with a sliding cover of the present invention.

FIG. 7 is a schematic view showing a close state of the handset with a sliding cover of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. For example, in the present invention, a handset with a sliding cover is used as an example, however other structure, such as a personal digital assistance (PDA) is also within the scope of the present invention.

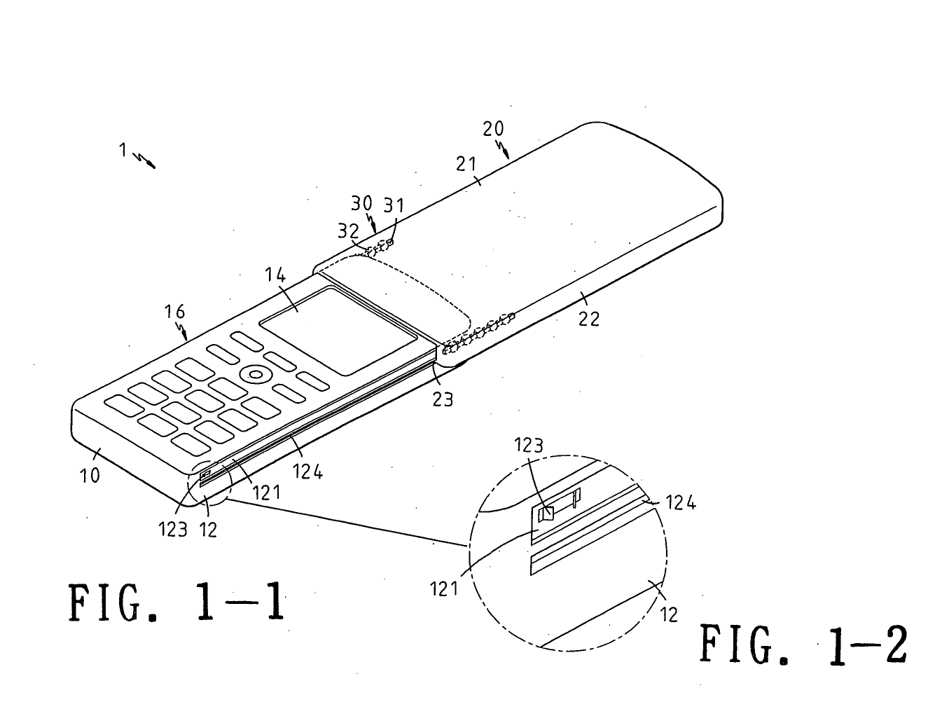

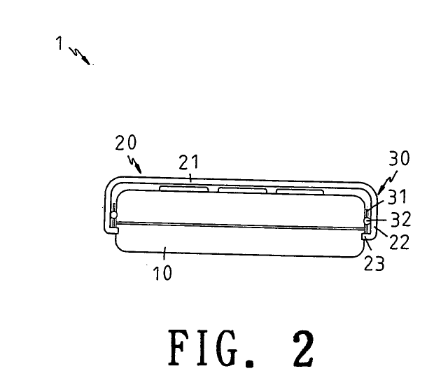

Referring to FIGS. 1 and 2, the structure of the present invention is described in the following.

A body 10 has an IC circuit and a detachable battery (all these are known in the prior art and thus the details will not be further described herein.) The body 10 has two lateral sides 12. An upper surface of the body 10 has a display screen 14 (a TFT display or an LCD display) at an upper area thereof and a key set 16 and a lower area thereof. Each of the two lateral sides 12 is formed with a track trench which receives a metal track sheet 121. Two ends of the metal track sheet 121 are formed with a first positioning portion 122 and a second positioning portion 123. The first positioning portion 122 and second positioning portion 123 are extended from a body of the metal track sheet 121 (referring to FIG. 1-2). A lower side of the track trench is formed with a limiting trench 124.

A cover 20 has an approximate U shape cross section. The cover 20 is slideably engaged to the body 10. The cover 20 has a body 10 and two lateral sides 22 extended from the body 10. An inner side of each lateral side 12 is formed with a guide portion 23. The guide portion 23 is received in the limiting trench 124 so that the cover 20 is slideable with respect to the body 10.

A slide unit is included. In this embodiment, the slide unit is a linear bearing 30 is received between the lateral sides 12 of the body 10 and lateral sides 22 of the cover 20. The linear bearing 30 includes a metal slide guide sheet 31 with a predetermined size and a plurality of rolling balls 32 rotatably embedded into the guide sheet 31.

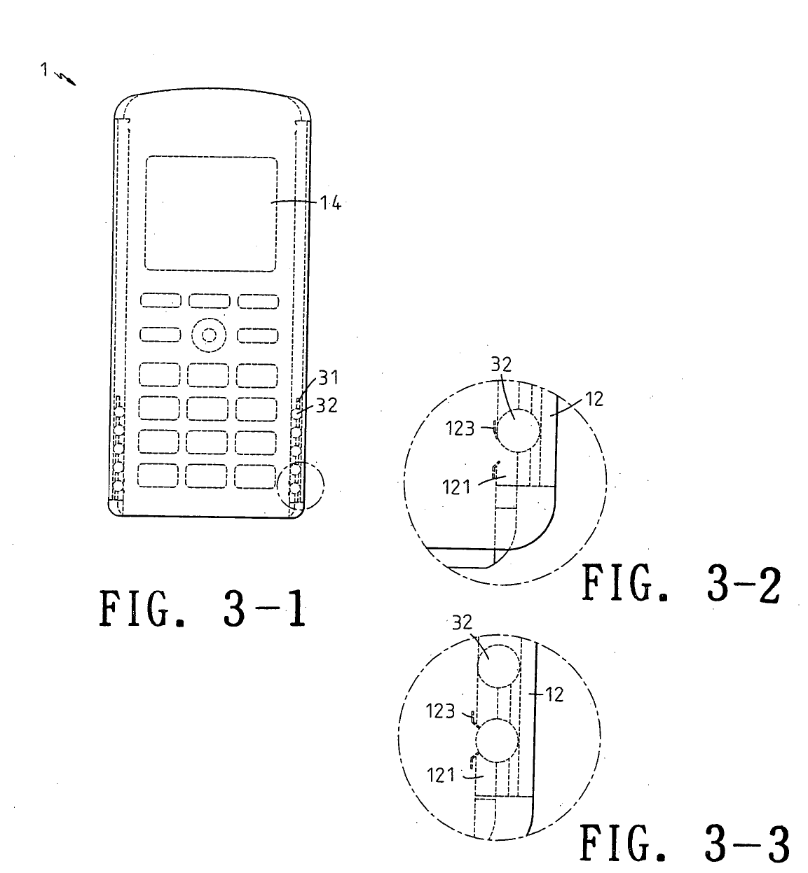

Referring to FIGS. 3-1, 3-2 and 3-3, a schematic view showing the covering state of handset with a sliding cover of the present invention is illustrated. In closing state, the cover 20 completely covers the body 10. One rolling ball 32 will fall into a notch between the first positioning portion 122 and the second positioning portion 123 so that the cover 20 tightly covers upon the body 10, as shown in FIG. 3-3.

Referring to FIG. 3-2, when the cover 20 is pushed to move away from the body, the rolling ball 32 in the notch will move away from the body 10. Thus, the cover 20 can be pushed away easily. In the present invention, the rolling ball 32 only slightly contact the metal track sheet 121 so that the friction force between the cover 20 and the body 10 is very small.

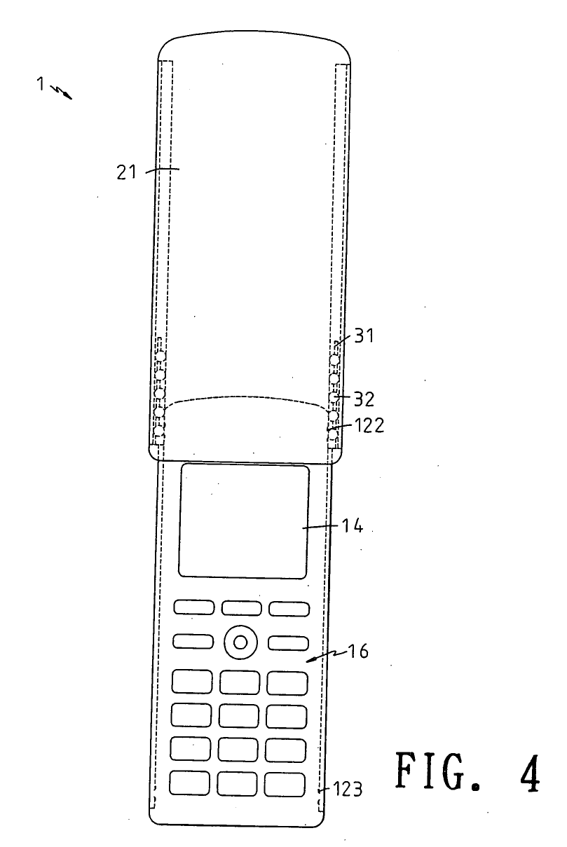

Referring to FIG. 4, when the cover 20 is pushed to an extreme end of the body 10, one rolling ball 32 will fall between the first positioning portion 122 and the second positioning portion 123 so that the cover 20 is confined in the position.

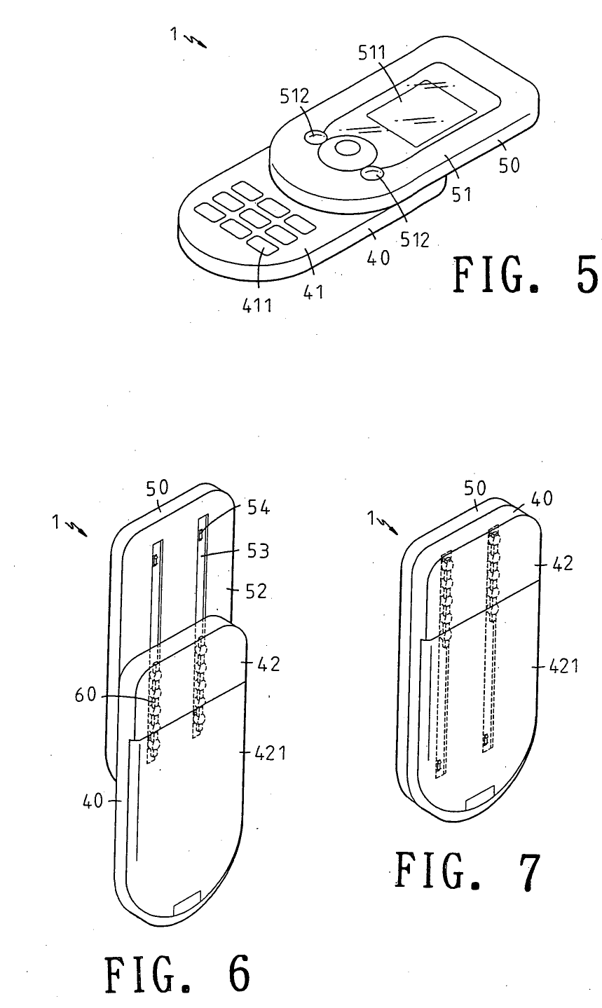

Referring to FIGS. 5 to 7, the second embodiment of the handset with a sliding cover of the present invention is illustrated. In this embodiment, the handset with a sliding cover has a body 40 and a cover 50 slideably assembled to the body 40. The body 40 is installed with an IC circuit assembly (not shown). A number key set 411 is installed on a top surface of the body 40. A bottom 42 of the body 40 is installed with a cap 521 for sealing a battery (not shown) in the body 40. A top surface of the cover 50 is installed with a display screen 511 and a function key set 512. A bottom surface 52 of the cover 50 is installed with two symmetric track grooves which are spaced apart. A metal track sheet 53 is installed in each track groove. An upper and a lower end of each metal track sheet 53 is formed with a set of positioning sheets 54 which are arranged as a [symbol] (a Chinese character, pronounced as “ba”) shape.

A linear bearing 60 is received between the body 50 and the cover 50 so that the cover 50 can be pushed smoothly with respect to the body 40. The linear bearing 60 is installed by a slideable guide sheet and a plurality of rolling balls rollably embedded in the guide sheet. The rolling balls are slightly in contact with the metal track sheet so that the friction force between the rolling balls and the metal track sheet is very small. Thus the cover 50 can be opened easily and smoothly.

Furthermore, in the present invention, a twisting spring can be installed between the body 40 and the cover 50. One leg of the twisting spring is connected to the body 40 and another leg thereof is connected to the cover 50. Thus, when the cover 50 is opened, the twisting spring is helpful to eject the cover and thus the cover 50 can be opened easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mobile communication device with a sliding mechanism comprising:
a body installed with an IC circuit and a detachable battery; a surface of the body is installed with a display screen and a key set;
a cover having an approximate U shape cross section; the cover being slideably combined to the body; at least side of the cover and body being installed with a liner bearing so that the cover is smoothly slideably with respective to the body.

2. The mobile communication device with a sliding mechanism as claimed in claim 1, wherein the mobile communication device is a mobile phone; each of two sides of the body is formed with a track groove and a limiting trench; a metal track sheet is embedded in the track groove; and the limiting trench is received with a guide portion.

3. The mobile communication device with a sliding mechanism as claimed in claim 1, wherein the linear bearing includes a metal slide guide sheet between two lateral sides of the cover and two lateral sides of the body and a plurality of rolling balls rotatably embedded into the guide sheet.

4. The mobile communication device with a sliding mechanism as claimed in claim 2, wherein the linear bearing includes a metal slide guide sheet between two lateral sides of the cover and two lateral sides of the body and a plurality of rolling balls rotatably embedded into the guide sheet.

5. The mobile communication device with a sliding mechanism as claimed in claim 2, wherein a front end and a rear end of the metal track sheet are bent upwards to be formed as a shape of [symbol] .

6. The mobile communication device with a sliding mechanism as claimed in claim 1, wherein a twisting spring is installed between the body and the cover; one leg of the twisting spring is connected to the body and another leg thereof is connected to the cover; and thus, when the cover is opened, the twisting spring is helpful to eject the cover and thus the cover can be opened easily.

7. The mobile communication device with a sliding mechanism as claimed in claim 1, wherein the mobile communication device is a personal digital assistor (PDA).

8. A mobile communication device with a sliding mechanism comprising:
a body installed with an IC circuit assembly; a number key set being installed on a top surface of the body; and
a cover assembled to the body; a top surface of the cover being installed with a display screen and a function key set; a bottom surface of the cover being installed with at least one track groove; and a liner bearing being received in the track groove.

9. The mobile communication device with a sliding mechanism as claimed in claim 8, wherein the mobile communication device is a mobile phone, the cover is installed with two track grooves, a metal track sheet is installed in each track groove; an upper and a lower end of each metal track sheet is formed with a set of positioning sheets which are arranged as a [symbol] (a Chinese character, pronounced as “ba”) shape.

10. The mobile communication device with a sliding mechanism as claimed in claim 8, wherein the linear bearing is formed of a slideable guide sheet and a plurality of rolling balls rollably embedded in the guide sheet.

11. The mobile communication device with a sliding mechanism as claimed in claim 8, wherein the mobile communication device is a personal digital assistor (PDA).
